(19) United States
(12) Patent Application Publication
(10) Pub. No.: US 2006/0289310 A1
(43) Pub. Date: Dec. 28, 2006

(54) PRECISION PARTS BY ELECTROPHORETIC DEPOSITION

(75) Inventors: DOUGLAS M. MATSON, BELMONT, MA (US); RAKESH VENKATESH, MEDFORD, MA (US)

Correspondence Address: JAMES E. MASLOW, ESQ., 4 FRANKLIN ROAD, LEXINGTON, MA, 02420, US

(73) Assignee: TUFTS UNIVERSITY, MEDFORD, MA (US)

(21) Appl. No.: 11/164,628

(22) Filed: Nov. 30, 2005

Related U.S. Application Data
(63) Continuation-in-part of application No. PCT/US05/00505, filed on Jan. 7, 2005.
(60) Provisional application No. 60/706,091, filed on Aug. 5, 2005.

(51) Int. Cl. C25D 13/00; B01D 59/42; C23F 17/00

(52) U.S. Cl. 204/484

(57) ABSTRACT

Precision parts and methods for electrophoretic deposition of precision parts from a slurry of fine particles deposited on a removable template, the slurry having a charge-assisting agent and a non-aqueous solvent, with the template encased by the formed part.

### RELATED APPLICATIONS

This application claims priority from U.S. Provisional Application No. 60/706,091, filed Aug. 5, 2005, and from PCT Patent Application Serial Number US05/00505, filed Jan. 7, 2005, and is a continuation of the latter. These applications are incorporated herein by reference in their entirety.

### FIELD OF THE INVENTION

The present invention relates generally to methods for forming precision parts, and in particular, to methods for creating precision parts using electrophoretic deposition.

### BACKGROUND OF THE INVENTION

Current research into microelectromechanical systems (MEMS) is providing a variety of submicron devices useful in a broad range of fields. However, current MEMS technology is focused almost exclusively on silicon and generally uses relatively slow micromachining techniques even for mass production of parts. Some current micromachining techniques include silicon micromachining, LIGA, microcasting, and microstereolithography (MSL). However, none of these processes is fully suitable for mass production, somewhat limiting the use of MEMS to a specialized applications where the expense of such techniques can be tolerated.

Stamping, casting and molding are well known methods of volume manufacture of parts for various products. The challenge is to provide high enough quality at low enough cost to meet the given need. One problem to be addressed is how to provide precision small parts, such as for MEMs devices, at low enough cost and in volume.

The need for small-scale precision comes in many forms. For example, the miniaturization of electromechanical devices and the resulting need for micro-power generation (milliwatts to watts) with low-weight, long-life devices together have fostered growth of the field of micro-scale combustion. Since batteries have low specific energy (˜200 kJ/kg) and liquid hydrocarbon fuels have a very high specific energy (˜50000 kJ/kg), a miniaturized power-generating device, even with a relatively inefficient conversion of hydrocarbon fuel to power, would result in increased lifetime and/or reduced weight of an electronic or mechanical system that currently requires batteries for power. In any event, it would enable relatively convenient remote power generation. However, low cost, volume manufacture of these precision devices remains illusive.

Thermophotovoltaic power generation is the conversion of thermal radiation to electrical energy directly. This is a promising area of technology. The typical TPV (thermophotovoltaic) system includes an element that converts heat or chemical energy to electrical energy without any moving parts. These devices can obtain thermal energy directly from combustors or by scavenging thermal energy from the environment. It is expected in the near future that reasonable conversion efficiency from thermoelectric elements will enable TPV devices that produce on the order of 1 watt of electric power per element.

Micro-Thermo-Photo-Voltaic power generation (MTPV) is TPV on a small scale. The MTPV system requires a radiation source, or emitter, such as can be provided by a micro-combustor. The emitter emits radiation, typically with black-body like spectrum. The combustor at a micro scale has a high surface to volume ratio which is desirable for using heat radiation as an energy source. SiC is commonly used to form such devices, which are typically operated at temperatures in the 1500-1800K range.

However, only a fraction of the energy at the heat source can be delivered to the photo-voltaic (PV) cell. It is desirable to increase the output power density by increasing the transferred energy. The solution to the problem lies in reducing the distance between the combustor emitter and the PV detector to a sub-micron scale.

When the distance is thus scaled down, evanescent modes at the emitter couple to the photo cell and begin to propagate. This enables the desired MTPV operation at higher efficiency. The amount of power that is transferred in this case is extremely high compared to the standard transfer rate. The massive increase in power transfer allows for significantly higher power density, which means a lighter-weight more efficient power source for many portable or remote applications.

A close and constant gap between energy source and photocell is the key to energy transfer efficiency. However, fabrication of a constant gap is extremely difficult. Currently devices with acceptable gaps have been manufactured using MEMS techniques, where dimensional tolerances can be well controlled. MEMS demonstrations have been made of silicon-based MTPV power generators with integrated catalytic combustors that operate at the milliwatt level.

There is a market for practical MTPV devices. However, MTPV devices, while promising, are not yet widely available. One fundamental roadblock is cost of manufacture, since present MEMS manufacturing processes do not lend themselves to low-cost manufacture. Therefore it is essential to define MTPV devices and to find cost-effective manufacturing techniques that can enable widespread commercialization of this appealing technology.

### SUMMARY OF THE INVENTION

Embodiments of the present invention include forming a shell on a patterned electrode (as a template) by deposition of charge-mobilized particles. The particles are presented in a slurry. The term “slurry,” as it is used herein, is intended to denote a mixture of solid and liquid components. Slurries may be solutions, suspensions, or combinations thereof, and may include multiple solids and liquids.

In practices of the invention, the electrode template is partially or fully immersed in the slurry. A charge is applied to this electrode (e.g., a positive voltage for cathodic deposition from a silica slurry). The slurry is held in a container which may be metallic so as to act as the other electrode of the electrophoretic process. Now, the charged particles in the solution are attracted to and deposited upon the template electrode.

In an embodiments of the invention, colloidal ceramic particles may include silica, glass, alumina, silicon nitride, silicon carbide, yttria, zirconia, or an oxide or nitride of aluminum or titanium. The particle size may be, for example, 75 μm, 40 μm, 10 μm, 1 μm, 100 nm, or 10 nm. But any material that may be dispersed in the suspension and subsequently aggregated to form a shell may be used. Borosilicate glasses may be deposited without the need for additives, but the addition of the agents increases the surface charge on the particles and increases deposition efficiency.

A charge-assisting agent, which may be a dispersion agent or surfactant or the like, is preferably added to the slurry to increase stability and function of the suspension. The agent enables or causes the particles in the slurry to be individually charged and thus to be able to be conveyed by the electric field to the electrode for deposition. In an illustrative embodiment, this charge-assisting agent is a salt, where the salt is present in sufficient quantity to impart an effective charge to the particles.

The dissolved salt may be a metal halide or carbonate, for example, sodium chloride, potassium chloride, rubidium chloride, cesium chloride, zinc chloride, potassium carbonate, or any metal salt or alkyl halide, and may be present in a concentration of up to 5% by weight. The salt may be at or below its saturation limit in the slurry.

In addition to these salts, this charge-assisting function may be served with amines, such as aminoethylethanoamine, or steric materials, such as propylene oxide copolymers. In any event, the desired result is that the particles in the slurry assume a charged state and retain that state while being transported in the electrified slurry to the electrode template for deposition and formation of the shell.

The slurry solution is preferably non-aqueous and preferably is formed using butanol (e.g., isobutanol or n-butanol). Alternatively, the slurry may include methanol, ethanol, propanol, or any other solution having a dielectric breakdown voltage greater than about 50 VDC). In one example, for deposition of 40 μm silica in butanol with an inter-electrode separation of about 2 centimeters on the cathodic electrode, operating voltage was 100 V at a current of 3-5 mA.

In one embodiment, the deposited shell was been found to have about 70% theoretical density (about 30% pore fraction by volume). The thickness may be controlled by the length of time that the voltage is applied. For the above conditions, an approximately 1 mm thick shell may be deposited in a time on the order of 5 minutes. Those of ordinary skill in the art will recognize that this deposition rate is extremely favorable as compared with the traditional investment casting technique of dipping in a slurry and drying successive layers, which might take several hours to achieve a comparable thickness.

In one illustrative practice of the invention, we have found that when depositing silica particles, good results are obtained when the ionic species is added at a concentration of at least 5-10% by weight. For best surface quality of the final molded part, the particle size of the shell should be small, at least for the first-deposited layers. Good surface quality has been obtained using a sol having an average particle size of about 40 μm, but particle sizes from 10 nm-75 μm have been found to be effective for use with the invention. For smaller particle sizes, it may be advantageous to deposit particles in a few layers, starting with very fine particles for the innermost layer (to enhance surface quality), and using coarser particles in subsequent layers (to speed buildup of the mold). Unlike conventional slurry techniques, layers do not generally have to be fully dried before additional layers are added to the shell.

Once a suitable thickness of ceramic has been built up, the green compact is dried. It is advantageous to conduct the drying operation in a single step at ambient pressure, although intermediate drying is possible if graded composite structures are to be formed, as further discussed below. For 40 μm silica particles, drying temperatures of about 25° C. provide good results without softening the template (which could cause warping).

It will be appreciated that a non-aqueous suspension having a low surface tension is preferred, as we have found that it minimizes cracking during the drying process. As the solvent dries and leaves the pores of the shell, capillary forces may pull the individual particles closer to one another. If drying is not completely homogeneous (which is likely for a shell having significant thickness or curvature), these capillary forces may be unbalanced and may lead to cracking. In any case, the low surface tension of a non-aqueous solvent reduces the effect of these capillary forces, minimizing cracking during the drying process.

The formed green shell is separated from the patterned template electrode. The template is sacrificial, or otherwise removable, to enable such separation without destruction of the formed green shell. As an illustration, a sacrificial wax patterned template electrode is removed by melting during sintering of the formed shell. In another illustration, a sacrificial template, such as one formed with carbon tubes, is removed by pyrolysis which may occur during sintering. Now the shell is available for use as a final part or as a step in a continuing process.

It will be appreciated that removal of the template electrode (e.g., wax electrode by melting, pyrolysis/vaporization, or leaching) is achieved in a manner that avoids damage to the deposited layer. Mechanical removal of the template electrode is also possible for some template-shell geometries, especially if conductive mold-release agents, such as graphite, are used, as long as damage to the deposited layer is avoided.

Sintering of the shell is preferred to improve mechanical integrity and density of the part. The desired degree of densification will depend upon the ultimate purpose of the part. Full or nearly full densification is achievable, and those of ordinary skill in the art will recognize that such densification is advantageous in resisting thermal shock.

Sintering is preferably accomplished at relatively low temperatures to limit monolith deformation. The temperature is set low enough to preclude viscous migration of pores or bubbles, to minimize physically changing the shape of the shell. For example, silica sintering may be performed at about 1200-1550° C. (e.g., at 1450° C. for four hours or at 1250° C. for twelve hours), while borosilicate glass sintering may be performed at about 850-900° C. Reactive or inert gas environments may be used, but we have found that sintering in air at ambient pressure for a duration of up to or over 18 hours with furnace cooling provides a well-formed product.

Those of ordinary skill in the art will understand that sintering and densification will be accompanied by a reduction in volume of the shell. With even temperature distribution and green shell density, this reduction in volume should be uniform. The volume reduction should be accounted for in designing the mold, so that the final part will be of the desired size (which will be smaller than the pattern size).

In some embodiments, electrophoretic fabrication may be combined with conventional dip-coating processes. Electrophoretic coating may be conducted immediately prior to subsequent dip-coating over an entire part. Following electrophoretic coating, the entire part may be dipped in a slurry of ceramic particles, for example, colloidal silica particles. The part is then dusted with dry silica (e.g., sand) and allowed to dry. The process may be repeated several times to build up the thickness of the coating.

It will be understood by those of ordinary skill in the art that our invention is not limited to any particular casting or molding process, but may be used in any process where a ceramic shell is built up on a template. The above-described processes are examples of the types of processes that may be performed using the invention.

The patterned template is conductive or at least critical surfaces are made conductive so as to perform the function of a patterned template electrode. The conductive material may be a metal or a conductive polymer or carbon, or it may include a combination of nonconductive and conductive material, or it may include a conductive coating (e.g., may be sputtered with a conductive material).

For example, a nonconductive template may be formed, such as with wax, and then coated with a conductive polymer or carbon or a fine conductive metal layer such as gold, silver, aluminum, or tin. Thus it will be appreciated that a patterned template electrode of the invention may be made with various materials as long as they enable the function of forming a shell on the surface of the patterned electrode template. The template may also include a release coat on its surface to assist in separation of the shell that forms on its surface.

In one illustration, a shell is deposited on the template by immersing the template in a slurry of colloidal particles, with the slurry containing a charge-assisting agent in a quantity sufficient to impart an effective charge to the particles, and applying a voltage to the template, thereby causing the charged particles to be deposited on the template to form a green shell. This is followed by sintering the green shell to its desired form.

The applied voltage may be about 100 V, and may produce a current of about 3-5 mA. The green shell may be 50%, 60%, or 70% dense (i.e., having a pore fraction of 50%, 40%, or 30% by volume, respectively), and may be dried before sintering. The method may also include second immersing and voltage-applying steps, to deposit more colloidal particles from a second plurality onto the green shell to increase its thickness.

In still another aspect, the invention includes a formed part, having a hollow shell with a plurality of partially or fully sintered particles and a measurable quantity of salt residue. The particle size may be as earlier described and the salt residue may include a metal halide or carbonate, for example, sodium chloride, potassium chloride, rubidium chloride, cesium chloride, zinc chloride, or potassium carbonate or other surfactant or the like, such as amines or steric materials.

In one embodiment, an illustrative method of depositing a component with a patterned interior includes the steps of a) forming a template having a patterned surface, b) immersing the template in a slurry, the slurry having a solvent, a plurality of colloidal particles, and a sufficient quantity of agent to assist or assure a charged state of the colloidal particles during the deposition process; c) applying a voltage to the template and causing the charged colloidal particles to be deposited on the template to form a green shell encasing or enveloping the template (with the template having a surface area which is mechanically captured within the green shell); d) forming a solidified shell; and e) removing the template without harming the formed shell, wherein the shell has an interior surface defined by the template patterned surface.

In an illustrative embodiment, the formed component is a ceramic combustor having an internal chamber formed as a network of internally connected channels. More particularly, this is a ceramic combustor for use in a MTPV power source. The combustor is formed having a network of internally connected channels by replication of a sacrificial template. The combustor preform is grown on and encasing a sacrificial template, thereby forming a ceramic body with an internal roadmap of interconnected template material. This green preform is sintered and densified to form a ceramic combustor body, with the template being pyrolized by the sintering. In one embodiment, the combustor is provided with small fluid channels on the order of 500-1 micron diameter. Thus a combustor with hermetically sealed faces and internally connected non-porous channels can be formed. These channels are accessed by ports that enable the desired fuel flow through the combustor. Inlet and outlet manifolds may be provided to assist the fluid flow.

The sacrificial template may be formed from a mesh (for example a plastic mesh or cloth) coated with a conductive surface layer, or itself is fabricated from conductive material. Alternatively, a series of sacrificial rods or tubes may form a conductive pattern to be used as a sacrificial template which after removal leaves the desired channel configuration. In an illustrative embodiment the rods are carbon fibers. In the EPD process, the ceramic shell grows around and encases the template. The template may be smooth or may be textured as will increase surface area of the formed part.

The combustion chamber includes a catalytic supply in the channels. In one embodiment, after the sacrificial template is removed, a catalyst is applied internally to the created fluid channels, typically in a wet process, to activate the combustion chamber. Alternatively the sacrificial template includes a catalytic component that remains after removal of the template.

The combustor may be integrated into an MTPV, preferably after at least one face of the combustor is polished (e.g., lapped) to present a flat surface area to the MTPV detector. Now the polished combustor face, as an emitter, is placed closely adjacent to the equally flat face of the thermophoto (TP) detector. Spacing is on the order of 0.5 μm, such that evanescent modes at the emitter couple efficiently into the detector. In one embodiment, front and back faces of the combustor are each lapped and serve as an emitter to a respective TP detector, and thus to be sandwiched between two TP detectors.

In use of the MTPV, a fuel source (such as hydrogen) is fed into the internal fluid channels of the combustor and is spontaneously combusted in the presence of the catalyst. This heat escapes at the combustor emitter face adjacent to the TP detector. The MTPV takes the waste heat from the emitter and converts it to electric power.

Various embodiments of the present invention are set forth in the attached figures and in the detailed description of the invention as provided herein and as further embodied by the claims. It should be understood, however, that this summary of the invention does not detail all embodiments of the present invention and is not meant to be limiting or restrictive in any manner. It will be further appreciated that the present invention is not limited by the disclosed illustrations and additional aspects of the invention will become readily apparent from the following discussion, particularly when taken together with the accompanying drawings.

### BRIEF DESCRIPTION OF THE DRAWINGS

Various objects, advantages and benefits of the present invention will be better understood when considered in conjunction with the following detailed description, making reference to the annexed drawings (not necessarily to scale), in which:

FIG. 1 is a perspective view of an MTPV device made in an illustrative practice of the invention;

FIG. 2. is a schematic layout of the manifolds and channels of the combustor of FIG. 1;

FIG. 3 is a perspective view of a green preform in practice of the invention; and

FIGS. 4-5 show illustrative steps for formation of the combustor of FIG. 1.

### DETAILED DESCRIPTION

It will be appreciated that the present invention teaches forming of precision parts with internal configurations of interest, and novel apparatus so formed. In an illustrative embodiment of the invention, a ceramic combustor for a MTPV power source is formed having internally defined features.

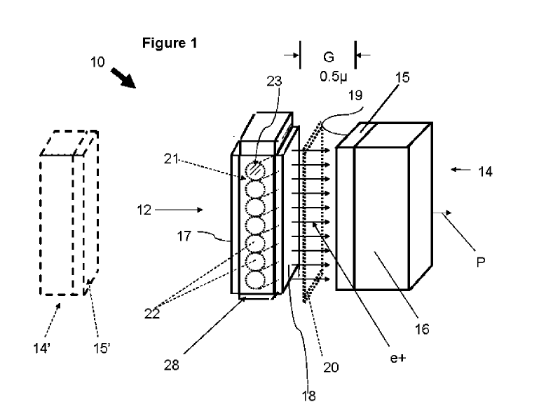

Turning to FIG. 1, MTPV generator apparatus 10 includes a ceramic micro-combustor 12 (“combustor”) and TPV converter 14. TPV converter 14 includes a thermal-photo (TP) detector 15 and a voltaic converter 16. Combustor 12 has a distal face 17 and a proximal emitter face 18, the latter facing the proximal detector face 19 of TP detector 15

Combustor 12 combusts fuel and generates waste heat, with consequent emission of energy e+ at emitter face 18. Emitter 18 is tightly coupled to TP detector 15, the latter for detection of energy e+ and generation of electrical power P output at converter 16.

A close and constant gap G between the energy source (emitter face 18) and detector photocell (PV face 19) is critical to energy transfer efficiency. Therefore, in a preferred embodiment, combustor face 18 and detector face 19 are parallel and closely spaced, separated by gap G preferably at about 0.5 μm. These faces have surface flatness on the order of 200 microns. The tight coupling of emitter 18 and TP detector 15, may be assisted by incorporation of a precision-formed spacer frame 20 (shown in dotted outline). Combustor distal face 17 may also be similarly finished, such as for interaction with a detector 15′ of converter 14′.

A catalytic combustion chamber 21 is defined within combustor 12. Combustion chamber 21 includes a plurality of internal channels 22. The channels are internally coated with a catalyst 23. The catalyst is deposited inside the channels by an suitable process. Channels 22 accommodate fuel-flow via manifold assembly 28.

Channels 22 may be formed in various manners and may have circular, rectangular or otherwise shaped cross-section. In fact, the channels shown in FIG. 1 are so closely spaced to each other as to present a figure “8” cross-section. This configuration closely couples the heat generation of the channels. It will be further appreciated that drawings are not to scale and that the channels are also closely coupled with and spaced close to the back side of the emitter to assist in heat transfer.

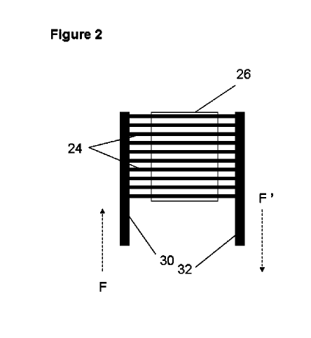

An illustrative parallel array of tubes 24 for forming channels 22 is shown schematically in FIG. 2 in communication with an inlet manifold 30 and an outlet manifold 32 of manifold assembly 28. The tubes are coated with catalyst 23, as shown in FIG. 1, and collectively form combustion chamber 21. In operation, fuel F passes from inlet manifold 30 into channels 22, whereupon the fuel is catalytically ignited and spent, and then spent fuel F′ exits through outlet manifold 32.

In an EPD process of the invention, channels 22 are formed using a sacrificial combination of conductive forms (e.g., tubes or rods in an array or grid, parallel or otherwise, hereinafter for convenience generally referred to without limitation as an “array or “arrays”). These may be wax, carbon, plastic or other organic materials, or leachable salts, or aluminum or other relatively low melting-point metals. These arrays may be inherently conductive, or they may be non-conductive and have a conductive surface, which may be applied as a coating, sputtered on, or the like. These arrays may be woven or formed as a lay-up, casting, stamping, or the like. In the illustrative embodiment of FIG. 2, tubes 24 are formed on or affixed to a frame or cross members 26 to assist in handling.

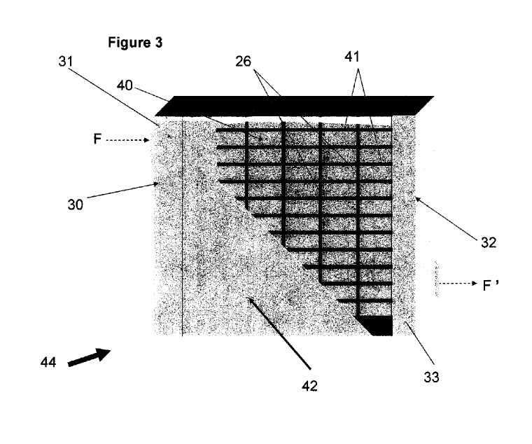

In any event, the array as an EPD electrode provides a conductive function so as to be able to attract ceramic particles during the sol investment process and yet it must remain sacrificial and be able to be removed thereafter. FIG. 3 shows an illustrative sacrificial array 40 in a cut-away view of a ceramic preform 44 formed in practice of the invention. This array is formed from any material that is conductive or that can be coated with a conductive layer and can be used if it can be melted, burned, leached or otherwise extracted out of preform 44 without leaving behind any unwanted artifact, and whose absence then defines acceptably uniform combustion channels that can be coated with catalyst.

In the illustration of FIG. 3, channel-forming array 40 includes parallel tubes 41 and mounting cross-members 26. Array 40 acts as a template shaped in the desired channel-forming configuration. It is placed in the EPD sol slurry and serves as an electrode for deposition of the charged ceramic particles so as to grow ceramic matrix 42 with an channel pattern. As the process proceeds, the array is encased and captured within ceramic matrix 42 to form a green perform 44.

The material of array 40 is selected with the goal of producing a smooth and clean-surfaced network of non-porous and well-defined combustion channels 22 with equal spacing between channels. The sacrificial material of array 40 is removed by wet or dry process. In a preferred embodiment, perform 44 is densified by sintering and the material of array 40 is removed by pyrolysis during the sintering process. Preferably, the resulting channels 22 are formed having on the order of 500-1 micron diameter upon firing, finishing, and densification of green preform 44. The process is done in a manner that eliminates voids in the formed channel walls so as to assure non-porous integrity of the channels. A variety of the forming process may include use of multiple ceramic particle sizes and use of multiple slurries. The process may be repeated so as to build up the thickness of the coating over the sacrificial template (array 40).

The channels are internally coated with catalyst 23, with the result of creating the desired catalytic combustion chamber, such as chamber 21 of FIG. 1. In operation, fuel F is introduced via inlet manifold 30 and flows into channels 41 to be catalytically combusted and flows out of outlet manifold 32 as spent fuel F′.

It will be appreciated that an illustrative EPD method of the invention includes several basic steps: forming the sacrificial template (e.g., array 40) and encasing that template in a permanent ceramic matrix (42), then followed by densifying, sacrificing the template, and finish processing the ceramic. It will be further understood by those of ordinary skill in the art that the invention is not limited to any particular casting or molding process for forming an array, ceramic shell, preform or part.

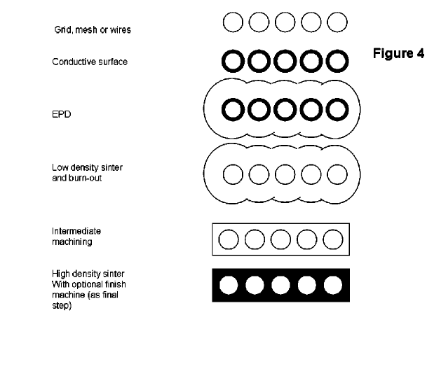

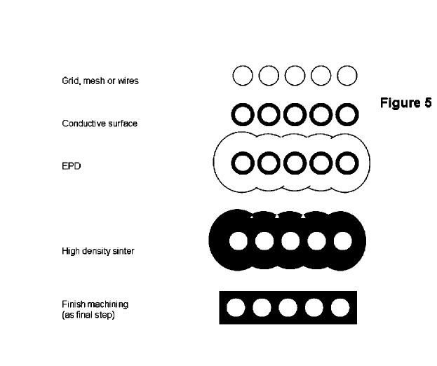

In an illustrative embodiment of the invention, ceramic preform 44 is built up on the sacrificial template (e.g. array 40) by EPD. This procedure is shown in FIGS. 4-5. First, the template is partially or fully immersed in a suspension of ceramic particles. A non-aqueous suspension having a low surface tension is preferred in that it minimizes cracking during the drying process. Butanol (e.g., isobutanol or n-butanol) is a suitable solvent; other potential solvents include methanol, ethanol, propanol, or any non-aqueous solvent having a sufficiently high dielectric breakdown voltage (preferably above 50 VDC). An ionic dispersion agent is preferably added to increase stability of the suspension (e.g., NaCl, KCl, CsCl, ZnC₁, K₂CO₃, or other metal salts or alkyl halides or amines, such as aminoethylethanoamine, or steric materials, such as propylene oxide copolymers). In any event, the desired result is that the particles in the slurry assume a charged state and retain that state while being transported in the electrified slurry for deposition.

When depositing silica particles, good results are obtained when the ionic species is added at a concentration of at least 5-10% by weight. Borosilicate glasses may be deposited without the need for additives, but the addition of the agents increases the surface charge on the particles and increases deposition efficiency.

Any material that may be dispersed in the suspension and subsequently aggregated to form a mold may be used (e.g., silica, glass, alumina, silicon nitride, silicon carbide, yttria, zirconia, or oxides or nitrides of aluminum or titanium). For best surface quality of the final molded part, the particle size of the ceramic should be small, at least for the first-deposited layers. Good surface quality has been obtained using a sol having an average particle size of about 40 μm, but particle sizes from 10 nm-75 μm have been found to be effective for use with the invention. For smaller particle sizes, it may be advantageous to deposit particles in a few layers, starting with very fine particles for the innermost layer (to enhance surface quality), and using coarser particles in subsequent layers (to speed buildup of the mold). Unlike conventional slurry techniques, layers do not generally have to be fully dried before additional layers are added to the shell-in-progress.

Once the template is immersed in the slurry, a voltage is applied to the template, wherein the template acts as an electrode to attract the charged ceramic particles. It will be appreciated that typically the sol solution particles are negatively charged, however it has also been found that if the ceramic powder is pulverized before being added to the slurry, the resulting particles will be imparted with a positive charge. Therefore, embodiments of the invention may be practiced with negatively charged particles which are attracted to a positively biased template (cathode) or with positively charged particles which are attracted to a negatively biased template (anode).

In any event, in embodiments requiring a conductive template, the template may be made of a conductive material such as a metal or a conductive polymer, or it may be a composite of nonconductive and conductive material, or it may be coated with a conductive material. For example, a nonconductive template may be coated with a fine conductive metal layer, for example, gold, aluminum, or carbon, by sputtering, or by use of conductive inks or the like.

Particles are deposited by electrophoresis on the template. For deposition of 40 μm silica in butanol with an inter-electrode separation of about 2 centimeters, preferred conditions are at a voltage of 100 V and a current of 3-5 mA. The resulting particulate layer has been found to have about 70% theoretical density (about 30% pore fraction by volume). The thickness may be controlled by the length of time that the voltage is applied; for the above conditions, an approximately 1 mm thick shell may be deposited in a time on the order of 5 minutes. Those of ordinary skill in the art will recognize that this deposition rate is extremely favorable as compared with the traditional investment casting technique of dipping and drying successive layers from an aqueous slurry, which might take several hours to achieve a comparable thickness.

Once a suitable thickness of ceramic has been built up, the green compact may be dried. It is advantageous to conduct the drying operation in a single step at ambient pressure, although intermediate drying in a controlled humidity environment is possible if graded composite structures are to be performed, as further discussed below. For 40 μm silica particles, drying temperatures of about 25° C. provide good results without softening the template (which could cause warping). The use of a solvent having low surface tension helps avoid cracking during drying. As the solvent dries and leaves the pores of the shell, capillary forces may pull the individual particles closer to one another. If drying is not completely homogeneous (which is likely for a shell having significant thickness or curvature), these capillary forces may be unbalanced and may lead to cracking. The low surface tension of butanol reduces the effect of these capillary forces, minimizing cracking during the drying process.

In some embodiments, fabrication may be combined with conventional dip-coating processes. For example the entire part may be dipped in a slurry of ceramic particles, for example, colloidal silica particles. The part is then dusted with dry silica (e.g., sand) and allowed to dry. The process may be repeated several times to build up the thickness of the coating.

The deposited particles are sintered to improve the mechanical integrity of the shell to full densification. Sintering is preferably accomplished at relatively high temperatures to encourage full densification. The temperature is preferably set high enough to encourage viscous migration of pores or bubbles and to enhance gas migration through the bulk ceramic product. Silica sintering may be performed at about 1200-1550° C. (e.g., at 1450° C. for four hours or at 1250° C. for twelve hours), while borosilicate glass sintering may be performed at about 850-900° C. Reactive or inert gas environments may be used, for instance use of helium gas to encourage diffusion from sealed bubbles, but sintering in air at ambient pressure for a duration of up to or over 18 hours with furnace cooling provides a well-formed product.

As shown in FIGS. 4-5, sintering may be accomplished in one or several steps. In a two-step process, the compact is fired to sufficient strength to allow the surfaces to be finished by grinding, lapping or polishing to obtain the desired flatness and bulk dimensions. The second sintering operation then takes the compact to nearly ideal density (such as to 92% density with isolated spherical pores in the structure) to preclude the retention of surface connected porosity which would cause leakage through the bulk and failure of the unit. In the one-step process, the compact is fired directly to final density and then finishing machining (grinding and polishing) operations are conducted. The template is sacrificed as discussed above.

Without limitation or restriction, an illustrative set of dimensions for an illustrative combustor 12 in practice of embodiments of the invention is on the order of 2.5 cm×2.5 cm×0.2 cm, with channels of variable size but on the order of 2 cm long by 100 microns deep by 100 microns wide with approximately 50 channels. The material of construction may be conventional silicon or for higher temperature combustor materials may use a ceramic oxide such as mullite, alumina, zirconia or silica, or nitrides such as silicon nitride or aluminum nitride.

Those of ordinary skill in the art will understand that sintering and densification will be accompanied by a reduction in volume of the shell. With even temperature distribution and green shell density, this reduction in volume should be uniform. The volume reduction should be accounted for in designing the mold, so that the final part will be of the desired size (which will be smaller than the pattern size).

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of forming a component with a patterned interior, comprising the steps of: (a) forming a template having a patterned surface; (b) immersing the template in a slurry, the slurry including a solvent, a plurality of particles, and a sufficient quantity of charge-assisting agent to impart an effective charge to many of the particles; (c) applying a voltage to the template and causing the charged particles to be deposited on the template to form a green shell on the template, the green shell substantially enveloping the template; (d) sintering the green shell to form a solidified shell; and (e) removing the template while leaving the shell having an interior surface defined by the template patterned surface.

2. The method of claim 1, wherein the template comprises a conductive material.

3. The method of claim 2, further comprising the step of removing the template from the green shell during the sintering step.

4. The method of claim 1, wherein the template comprises a conductive coating.

5. The method of claim 2, wherein the conductive material is a sputtered coating.

6. The method of claim 1, wherein the slurry is non-aqueous and the agent is a salt.

7. The method of claim 1, wherein the slurry comprises an organic solvent and the agent is a salt.

8. The method of claim 6, wherein the solvent is selected from the group consisting of butanol, methanol, ethanol, and propanol.

9. The method of claim 1, wherein the colloidal particles comprise a material selected from the group consisting of silica, glass, alumina, silicon nitride, silicon carbide, yttria, zirconia, and oxides and nitrides of aluminum and titanium.

10. The method of claim 1, wherein the colloidal particles have an average particle size of less than 75 μm.

11. The method of claim 1, wherein the colloidal particles have an average particle size of less than 40 μm.

12. The method of claim 1, wherein the colloidal particles have an average particle size of less than 10 μm.

13. The method of claim 1, wherein the colloidal particles have an average particle size of less than 1 μm.

14. The method of claim 1, wherein the colloidal particles have an average particle size of less than 100 nm.

15. The method of claim 1, wherein the colloidal particles have an average particle size of less than 10 nm.

16. The method of claim 1, wherein the agent is a salt selected from the group consisting of sodium chloride, potassium chloride, rubidium chloride, cesium chloride, zinc chloride, and potassium carbonate.

17. The method of claim 1, wherein the agent is selected from the group consisting of amines and steric materials.

18. The method of claim 17, wherein the agent is carbonate.

19. The method of claim 1, wherein the agent is a metal or alkyl halide.

20. The method of claim 1, wherein the salt is present in a concentration of 5% by weight or less.

21. The method of claim 1, wherein the salt is present at a concentration in the slurry that is at or below its solubility limit.

22. The method of claim 1, wherein the applied voltage is about 100 volts.

23. The method of claim 22, wherein the applied voltage produces a current of about 3-5 mA.

24. The method of claim 1, wherein the green shell has a pore fraction not greater than 40% by volume.

25. The method of claim 1, wherein the green shell has a pore fraction not greater than 30% by volume.

26. The method of claim 1, further comprising drying the green shell prior to sintering.

27. The method of claim 1, further comprising: after immersing the template and applying a voltage, immersing the template in a second slurry comprising a second plurality of colloidal particles; and applying a second voltage to the template to cause the second plurality of colloidal particles to be deposited on the green shell to increase its thickness.

28. A method of producing a desired patterned article, comprising: (a) forming a template having components that form a grid; (b) immersing the template in a slurry, the slurry comprising a solvent, a plurality of colloidal particles, imparting an effective charge to the colloidal particles by applying a voltage to the template and causing the colloidal particles to be deposited on the template to form a green shell; (c) sintering the green shell to form a solidified shell having an interior grid surface defined by the template grid; and (d) removing said template without destroying said shell.

29. The method of claim 27 wherein the template components include tubes.

30. The method of claim 27 wherein the template components include rods.

31. The method of claim 27 wherein the template is sacrificial and is dominated by carbon forms.

32. The method of claim 27 wherein the solidified green shell defines a network of internally connected channels formed by removal of the template components.

33. The method of claim 31 wherein the particles are ceramic and the solidified green shell forms a combustor having an internal network of combustion surfaces, wherein the combustion surfaces include a catalyst.

34. A combustor formed by the process of claim 32.

35. The method of claim 1 wherein the charge-assisting agent is an amine.

36. The method of claim 1 wherein the charge-assisting agent is a steric material.

37. A MTPV device having a combustor formed by the process of claim 34.
